(19) United States
(12) Patent Application Publication
(10) Pub. No.: US 2026/0239025 A1
(43) Pub. Date: Aug. 13, 2026

(54) AI/ML BASED WTRU CONFIGURATION PARAMETER RETUNING

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US); Faris Alfarhan, Montreal (CA); Michael Starsinic, Newtown, PA (US); Ulises Olvera-Hernandez, Saint-Lazare (CA); Dylan Watts, Montreal (CA)

(73) Assignee: InterDigital Patent Holdings, Inc., Wilmington, DE (US)

(21) Appl. No.: 19/049,954

(22) Filed: Feb. 10, 2025

(51) Int. Cl. H04W 24/02; H04L 41/0823; H04L 41/14; H04L 41/147

(52) U.S. Cl. CPC H04W 24/02; H04L 41/0823; H04L 41/145; H04L 41/147

(57) ABSTRACT

Methods, apparatuses, and systems are disclosed. In one example, a method performed by a wireless transmit/receive unit (WTRU) includes receiving an indication of a relation between a key performance indicator and a configuration parameter; receiving an indication of a range of values that can be assigned to the parameter and an initial value for the parameter; receiving configuration information that indicates a first condition associated with the key performance indicator; in response to a determination that the first condition has been satisfied, determining an updated value for the configured parameter, wherein the updated value is within the range of the values, to achieve a second condition associated with the key performance indicator using a model; and in response to a determination that the updated value is to be assigned to the configuration parameter, performing one or more actions.

### BACKGROUND

The Third Generation Partnership Project (3GPP) has begun to describe mechanisms and/or frameworks for using approaches based on artificial intelligence and/or machine learning (AI/ML) at various levels. For instance, the 3GPP has described AI/ML-based approaches at the air interface level for channel state information (CSI) feedback enhancements (e.g., CSI compression), beam management/prediction, and WTRU positioning. The 3GPP has also described AI/ML-based approaches at the network level for network energy saving, load balancing, and mobility management. AI/ML-based approaches at other levels are also possible.

### SUMMARY

Methods and apparatuses for operation by a wireless transmit/receive unit (WTRU) in a network are provided.

In one example, a method performed by a WTRU may include receiving an indication of a relation between a key performance indicator and a configuration parameter; receiving an indication of a range of values that can be assigned to the parameter and an initial value for the parameter; receiving configuration information, wherein the configuration information indicates a first condition associated with the key performance indicator; in response to a determination that the first condition has been satisfied, determining an updated value for the configured parameter, wherein the updated value is within the range of the values that can be assigned to the parameter, to achieve a second condition associated with the key performance indicator using a model; and in response to a determination that the updated value is to be assigned to the configuration parameter, performing one or more of the following actions: (i) applying the updated value for the configuration parameter at the WTRU; (ii) sending an indication to a network that the updated value for the configuration parameter has been applied at the WTRU; or (iii) sending a request to the network to request that the initial value of the configuration parameter be changed to the updated value.

The configuration parameter may be associated with an information element.

The configuration parameter may be used to configure the WTRU for operation or communication with the network.

The configuration parameter may comprise one or more of: a timer or a counter.

The key performance indicator may comprise a metric that is associated with throughput or latency of communication between the WTRU and the network.

The method may further comprise sending an indication that the WTRU is capable of performing optimization of the key performance indicator by modifying the initial value of the configuration parameter.

The WTRU may be capable of performing the optimization of the key performance indicator by using an artificial intelligence and/or machine-learning (AI/ML) model, wherein the model comprises the AI/ML model.

The method may further comprise: receiving a request from the network for information that indicates whether the AI/ML model is applicable to perform optimization of the key performance indicator by modifying the initial value of the configuration parameter; determining that the AI/ML model is applicable for performing optimization of the key performance indicator for the WTRU and for current network conditions associated with the network; and sending an applicability report that indicates that the AI/ML model is applicable for performing optimization of the key performance indicator for the WTRU and for the current network conditions associated with the network.

The first condition may comprise one or more of an absolute key performance indicator threshold or a relative key performance indicator threshold.

The second condition may comprise one or more of an absolute key performance indicator threshold or a key performance indicator threshold relative to the first condition.

The second condition may define an upper bound for the key performance indicator or a lower bound for the key performance indicator.

In another example, a wireless transmit/receive unit (WTRU) may comprise a processor configured to: receive an indication of a relation between a key performance indicator and a configuration parameter; receive an indication of a range of values that can be assigned to the parameter and an initial value for the parameter; receive configuration information, wherein the configuration information indicates a first condition associated with the key performance indicator; in response to a determination that the first condition has been satisfied, determine an updated value for the configured parameter, wherein the updated value is within the range of the values that can be assigned to the parameter, to achieve a second condition associated with the key performance indicator using a model; and in response to a determination that the updated value is to be assigned to the configuration parameter, perform one or more of the following actions: (i) apply the updated value for the configuration parameter at the WTRU; (ii) send an indication to a network that the updated value for the configuration parameter has been applied at the WTRU; or (iii) send a request to the network to request that the initial value of the configuration parameter be changed to the updated value.

The configuration parameter may be associated with an information element.

The configuration parameter may be used to configure the WTRU for operation or communication with the network.

The configuration parameter may comprise one or more of: a timer or a counter.

The key performance indicator may comprise a metric that is associated with throughput or latency of communication between the WTRU and the network.

The processor may be further configured to send an indication that the WTRU is capable of performing optimization of the key performance indicator by modifying the initial value of the configuration parameter.

The WTRU may be capable of performing the optimization of the key performance indicator by using an artificial intelligence and/or machine-learning (AI/ML) model, and wherein the model comprises the AI/ML model.

The processor may be further configured to: receive a request from the network for information that indicates whether the AI/ML model is applicable to perform optimization of the key performance indicator by modifying the initial value of the configuration parameter; determine that the AI/ML model is applicable for performing optimization of the key performance indicator for the WTRU and for current network conditions associated with the network; and send an applicability report that indicates that the AI/ML model is applicable for performing optimization of the key performance indicator for the WTRU and for the current network conditions associated with the network.

The first condition may comprise one or more of an absolute key performance indicator threshold or a relative key performance indicator threshold.

The second condition may comprise one or more of an absolute key performance indicator threshold or a key performance indicator threshold relative to the first condition.

The second condition may define an upper bound for the key performance indicator or a lower bound for the key performance indicator.

In another example, a WTRU may comprise a processor configured to receive an indication of a relation between a key performance indicator and a configuration parameter; receive configuration information, wherein the configuration information indicates a start condition associated with determining a value for the configuration parameter based on the key performance indicator; in response to a determination that the start condition has been satisfied, determine the value for the configured parameter to achieve a target value for the key performance indicator using an artificial intelligence and/or machine learning (AI/ML) model; and in response to a determination that the value for the configuration parameter has been determined, perform one or more of the following actions: (i) apply the value for the configuration parameter at the WTRU; (ii) send an indication to a network that the value for the configuration parameter has been applied at the WTRU; or (iii) send a request to the network to request that a current value of the configuration parameter be changed to match the value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram that shows an example set of actions that may be performed by a WTRU.

### DETAILED DESCRIPTION

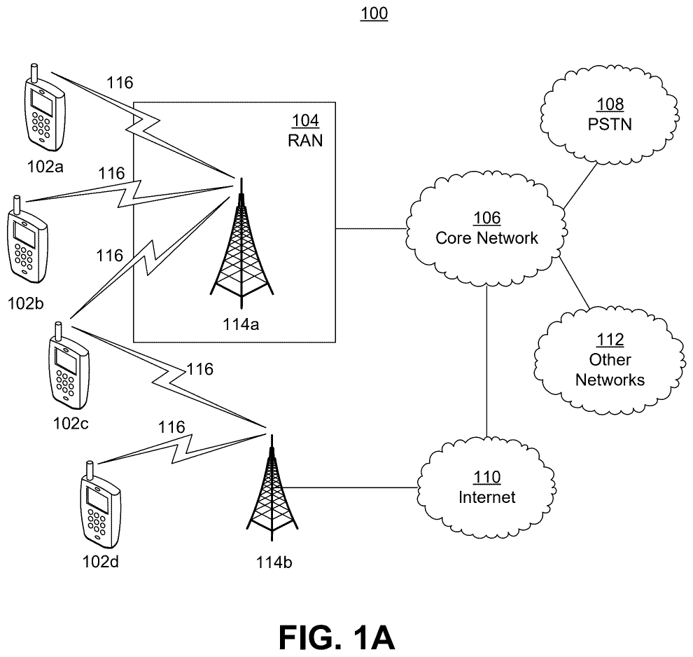

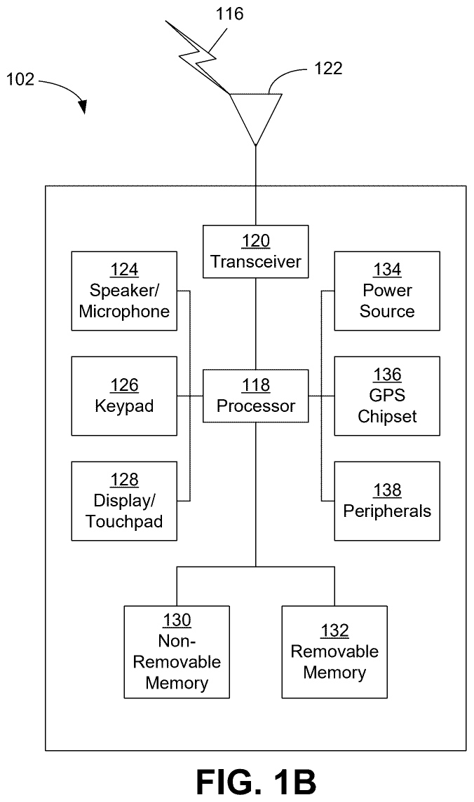

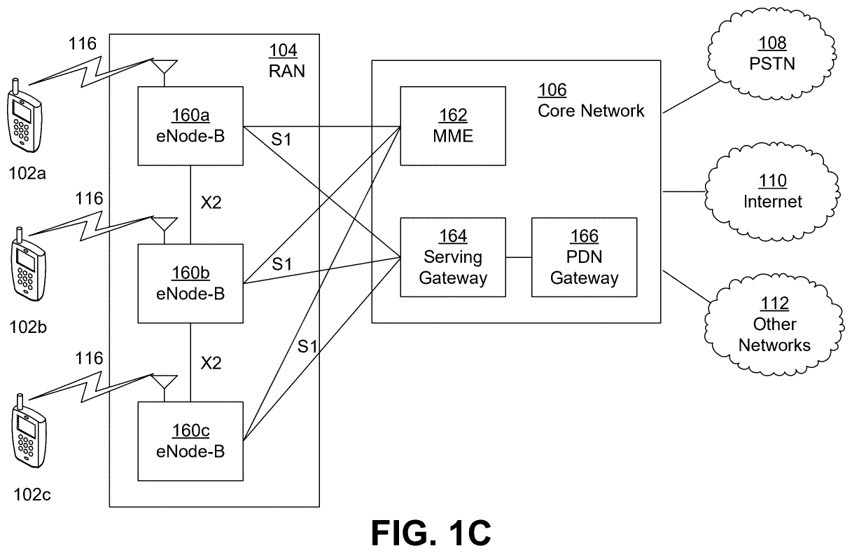

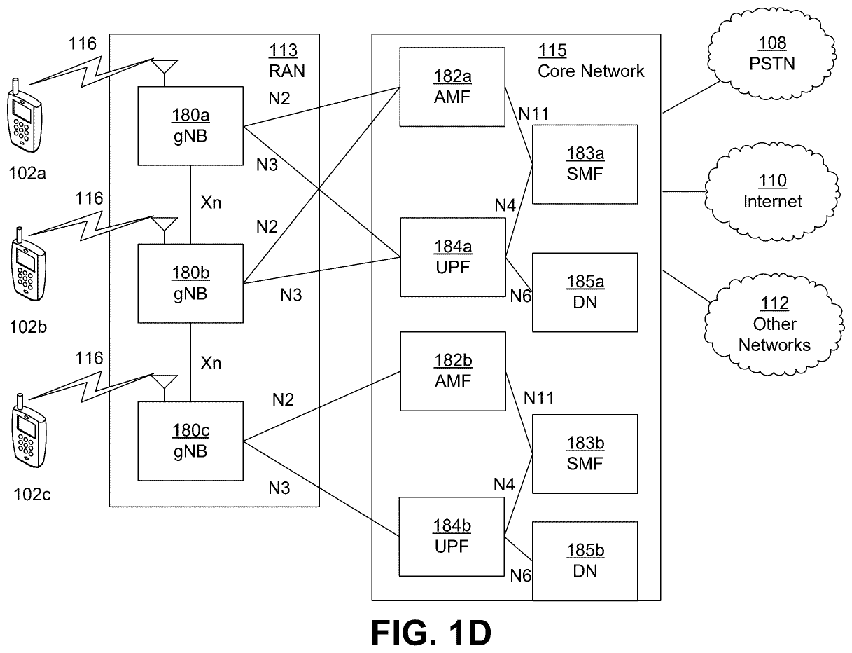

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The Third Generation Partnership Project (3GPP) has begun to describe mechanisms and/or frameworks for using approaches based on artificial intelligence and/or machine learning (AI/ML) at various levels. For instance, the 3GPP has described AI/ML-based approaches at the air interface level for channel state information (CSI) feedback enhancements (e.g., CSI compression), beam management/prediction, and WTRU positioning. The 3GPP has also described AI/ML-based approaches at the network level for network energy saving, load balancing, and mobility management. AI/ML-based approaches at other levels are also possible.

AI/ML approaches may be based on models (e.g., neural networks, among other possible model types of AI/ML models) that have been created and/or trained using a large amount of data collected in different scenarios and/or under different conditions. Such conditions may take various forms, such as WTRU-side conditions and/or network-side conditions. A speed at which a WTRU is moving may be an example of a WTRU condition (among other possible types of WTRU conditions). An antenna pattern may be one example of a network-side condition, while a load (e.g., of network traffic) may be another example of a network-side condition (among other possible types of network-side conditions).

For a given AI/ML functionality (e.g., which may include one or more AI/ML-based operations), there may be one or more models created and/or trained to perform that given AI/ML functionality. In some examples, for example, if several different models are created and/or trained to perform the given AI/ML functionality, one of those different models may be created and/or trained to be suitable for use under a first set of conditions, while another one of those different models may be created and/or trained for use under a second set of conditions. In another example, several different models may be created and/or trained for use under the same set of conditions. Other examples are also possible.

Once a model has been created and/trained, the model may be deployed for performance testing (e.g., in a test environment and/or a test network). Even after a model has been deployed in a production environment (e.g., in a “real” and/or live network), the model may continue to be monitored. Monitoring the model after deployment in a production environment may allow the model's performance to be evaluated as conditions (e.g., WTRU-side conditions and/or network-side conditions) in the production environment may, at times, differ from the conditions that applied when data used to create and/or train the model was generated and/or collected.

If data collected via the monitoring indicates the model's performance is undesirable (e.g., with respect to a WTRU, a network, etc.), a decision may be made to switch to using another model to perform the given AI/ML functionality or to stop using AI/ML-based operations (e.g., as performed using AI/ML models) to perform the given AI/ML functionality. The performance monitoring can also be used to determine whether to retrain the model with updated data (e.g., updated training data).

A model may be created and/or trained at a WTRU, at a network to which the WTRU may connect (e.g., a base station, a remote radio head, etc.), and/or at a combination of locations that may include the WRTU and/or one or more locations within the network.

A model may be created and/or trained via a computing system (e.g., comprising a processor) that is online (e.g., at a network-connected location), offline (e.g., at a location that is not connected to a network at the time of creation/training).

In order to order to operate properly in a radio network, a WTRU has to be provided with several WTRU configurations (with associated configuration parameters and values for those configuration parameters). In general, WTRU configurations may be divided into two categories: access stratum (AS) configurations associated with an AS layer and non-access stratum (NAS) configurations associated with an NAS layer. AS configurations may relate to communication between the WTRU and the radio network (e.g., a radio access network (RAN) via a base station (e.g., a next generation node B (gNB) or some other type of base station). NAS configurations may relate to communication between the WTRU and a core network (CN).

AS configurations may be handled via a Radio Resource Control (RRC) sublayer and/or RRC protocol, while NAS configurations may be handled via a Non-Access Stratum (NAS) layer and/or NAS protocol.

The RRC sublayer manages the establishment, maintenance, and termination of an RRC connection between the WTRU and the network (e.g., including the RAN and/or the CN). The RRC sublayer provides a set of configuration parameters that are used for operation of various functions and services provided by various layers, such as a Physical (PHY) layer, a Medium Access (MAC) layer, a Radio Link Control (RLC) layer, a Packet Data Convergence Protocol (PDCP) layer, and other layers (e.g., higher layers). The details of the RRC protocol associated with the RRC sublayer may, for example, be defined in a technical specification (e.g., for the 5G standard, the details of RRC protocol may be found in Technical Specification (TS) 38.331).

Furthermore, the RRC sublayer may configure Quality of Service (QoS) management functions that are used to ensure network traffic is prioritized (e.g., according to significance as measured by one or more metrics and/or in accordance with any QoS requirements). The RRC sublayer may be used to configure communication channels (e.g., radio bearers) with parameter values that are aligned with any applicable QoS requirements of the communication channels (e.g., requirements that specify priorities, bit rates, delay budget, etc.). The network can ensure the WTRU gets sufficient resources for the transmission of uplink (UL) data and the reception of downlink (DL) data via the configuration at the RRC sublayer of semi-persistence scheduling resources (SPS) and configured grants (CG)s, respectively. Additionally, the RRC sublayer may specify WTRU measurement reporting (e.g., controlling the frequency and/or consistency of WTRU measurement reporting) and/or specify channel state reporting (e.g., ensuring rapid detection and recovery from any radio link failures), among other possibilities. The RRC sublayer may act as a conduit for the transfer of NAS messages between the NAS layer and the WTRU, maintaining bidirectional communication integrity.

In addition, the RRC sublayer may provide configuration of a WTRU security context of the WTRU. The WTRU security context may include security keys and security algorithms to be used for the encryption and integrity protection of signaling radio bearers (SRBs) and/or data ratio bearers (DRBs). Furthermore, the RRC sublayer may also ensure the robust establishment, configuration, and management of radio bearers. The RRC sublayer may further specify mobility functions and/or operations, handovers, context transfers, cell selection and/or reselection (e.g., when the WTRU is in an IDLE mode), and/or detection and/or recovery from radio link failures, among other possibilities.

The NAS layer, on the other hand, may support functions such as mobility management (MM) procedures between the WTRU and the network, session management (SM) procedures between the WTRU and the network. Furthermore, the NAS layer may transport containers between the WTRU and the network.

NAS-MM refers to NAS protocol messages and procedures that may be used for mobility management. For example, in a 5G system, NAS-MM messages may be sent to an Access and Mobility management Function (AMF). An AMF is an example of a network function that may provide access and mobility-management functionality.

NAS-SM refers to NAS protocol messages and procedures that may be used for session management. For example, in a 5G system, NAS-SM messages may be sent to a Session Management Function (SMF). An SMF is an example of a network function that may provide session management functionality.

NAS procedures (e.g., procedures associated with the NAS) may, in some instances, be triggered or blocked based on the configuration of timers (e.g., the values for configuration parameters that serve as timers).

In current wireless networks, for both RRC-related and NAS-related configurations, a single respective value is configured for each configuration parameter. Timers are one example of a type of configuration parameter. Some examples of timers include a prohibit timer, a retransmission timer, a discard timer, a handover timer, counters for determining radio link/beam failure/recovery, timers for controlling NAS-level procedures such as a registration update timer, and/or backoff timers for Protocol Data Unit (PDU) session establishment requests, among other possible types of configuration parameters. Other types of timers and other types of configuration parameters are also possible.

As noted above, in current wireless networks, a single respective value is configured for each configuration parameter. Such a value is often configured conservatively (e.g., for a worst-case scenario) and/or globally (e.g., as a global value) to accommodate a wide range of possible types of WTRU behaviors and/or reactions. This can often lead to sub-optimal performance (e.g., as indicated by delayed retransmissions, delayed discards, reduced throughputs, increased packet error rates, delayed handovers, and/or delayed triggers of failures and failure recovery, among other possible indicia of sub-optimal performance).

In practice, there may be thousands of possible configuration parameters that are related to the AS layer and/or the NAS layer. Given this large number of possible configuration parameters, it may be difficult to set the configuration parameters optimally (e.g., to determine and/or identify values for the configuration parameters that would result in optimal or near optimal performance). Therefore, it may become desirable (e.g., in order to achieve better and/or more optimal performance) for a series of RRC reconfigurations and/or NAS reconfigurations (e.g., which may include updated values for the configuration parameters) to be sent to the WTRU. The signaling involved in sending these reconfigurations to the WTRU may result in air interface overhead and/or CN signaling overhead, among other possible problems.

A more scalable approach (e.g., than sending reconfigurations with updated values for reconfiguration parameters) may be to make it possible for the WTRU to change some of the values for some of the configuration parameters (e.g., within a respective range of possible values for each configuration parameter, where the respective range may be configured by the network and/or be based on one or more metrics that are being monitored to measure performance). Key Performance Indicators (KPIs) are one example of a type of metric that may be used to monitor performance, although other types of metrics may be used. The WTRU may use one or more AI/ML models to determine respective values for the configuration parameters that, when applied to the configuration parameters, facilitate achievement of a target value for the metric (or, if more than one metric is used, respective target values for the metrics).

The target value for a metric that is used to monitor performance (e.g., a KPI) may be considered to be achieved when an observed value of the metric (e.g., observed via monitoring) matches the target value and/or when the observed value of the metric is bounded by the target value satisfies a threshold indicated by the target value. For instance, consider an example in which the metric is latency (e.g., measured in milliseconds (ms)) and the target value is three milliseconds. In this example, the target value may be considered to be achieved by an observed latency value that is less than or equal to the target value of three milliseconds. Thus, in this example, the target value defines an upper bound of values for the metric that are considered to achieve the target value. On the other hand, consider another example in which the metric is throughput and the target value is ten gigabits per second (Gbps). In this example, that target value may be considered to be achieved by an observed throughput value that is greater than or equal to ten Gbps. Thus, in this example, the target value defines a lower bound of values for the metric that are considered to achieve the target value.

The target value applies to the metric that is used to monitor performance may be specified by a condition (e.g., a stop condition) such that the condition (e.g., by virtue of specifying the target value) defines an upper bound and/or lower bound for the metric.

As discussed above, the 3GPP has described AI/ML-based approaches (e.g., AI/ML functionalities) for CSI feedback enhancements, beam management/prediction, WTRU positioning, network energy saving, load balancing, and mobility management. These AI/ML functionalities described by the 3GPP can be grouped together into a single category of AI/ML-based approaches in which an AI/ML model is trained and/or configured to (i) predict one or more outputs (e.g., to predict beam and/or cell signal levels, to identify a preferred cell/beam from among available cells/beams based on respective values for the available cells/beams for a metric such as a Reference Signal Received Power (RSRP), to predict the position of a WTRU, etc.) and (ii) utilize the one or more outputs is to optimize WTRU operations and/or network operations (e.g., by reducing WTRU measurements, predicting future measurements that can be sent to the network to facilitate proactive and/or preemptive action in response to the predicted measurements, etc.).

The problem of determining respective values for one or more configuration parameters to achieve a target value of a metric used to measure performance (e.g., a KPI) based on AI/ML models differs from the problem of predicting one or more outputs (e.g., from the type of problem the AI/ML functionalities described by the 3GPP are meant to address) in a number of ways.

For instance, there may be many configuration parameters that may affect a given metric used to measure performance (e.g., a KPI such as throughput or latency).

A set of configuration parameters that may be modified in furtherance of achieving a target value for the given metric (which may be a subset of the configuration parameters that may affect the given metric) might not be known. As a result, the set of configuration parameters that may be modified may have to be determined and/or predicted.

Furthermore, once the set of configuration parameters has been determined and/or predicted, respective values for the configuration parameters in the set to achieve the target value for the given metric may also have to be determined and/or predicted.

Thus, the current AI/ML Life Cycle Management (LCM) framework (e.g., as reflected by the AI/ML-based approaches described by 3GPP) that is designed for prediction of one predefined parameter and/or output is not sufficient to address the problem of determining respective values for one or more configuration parameters to achieve a target value of a metric used to measure performance (e.g., a KPI) based on AI/ML models.

Therefore, the problem of how to define an AI/ML LCM framework for the determination/prediction of different configuration parameters (e.g., AS and/or NAS parameters) and respective values for those configuration parameters for the optimization of different metrics (e.g., for the achievement of target values for those metrics) is not addressed by existing solutions.

The present disclosure describes technological solutions for addressing the problems described above. In some examples, these technological solutions involve configuring a WTRU to perform an AI/ML-based prediction of respective values for one or more configuration parameters to optimize a given configured metric (e.g., KPI). In some examples, the respective values may be constrained to fall within a configured range of possible parameter values. The WTRU may further be configured to be able to apply the respective values for the one or more configuration parameters (e.g., to modify and/or update current values of the one or more configuration parameters to match the respective values). Furthermore, in some examples, the WTRU may send the network (e.g., a RAN and/or a CN) an indication that the respective values have been applied. In some examples, the WTRU may send a request to the network for permission to apply the respective values to the one or more configuration parameters and await a message from the network granting the requested permission before applying the respective values to the one or more configuration parameters.

In some examples, a WTRU may perform a set of one or more actions to implement technological solutions described in the present disclosure.

For instance, in one example, the WTRU may receive a relation that associates one or more metrics (e.g., KPIs) with one or more configuration parameters (e.g., WTRU configuration parameters).

In addition, the WTRU may send an indication (e.g., to the network, in the form of a capability report or in some other form) to indicate that the WTRU is capable of optimizing one or more metrics (e.g., KPIs) based on one or more configuration parameters via a model (e.g., an AI/ML model).

Furthermore, the WTRU may receive a request from the network to report if and/or when the model that may be used to optimize the one or more metrics based on the one or more configuration parameters becomes applicable (e.g., if and/or when a condition comprising a start threshold is satisfied). In some examples, a condition comprising a start threshold may be referred to as a “first condition” and/or a “start condition.”

The WTRU may also determine that the model is applicable and send an indication (e.g., an applicability report) to the network to indicate that the model is applicable (e.g., that a condition comprising a start threshold is satisfied).

In addition, the WTRU may receive (e.g., from the network) a configuration to optimize the one or more metrics (e.g. KPIs) based on the one or more configuration parameters. The configuration may comprise one or more conditions associated with determining the respective values for the one or more configuration parameters and/or associated behavior of the WTRU to be performed after respective values for the one or more configuration parameters have been determined (e.g., in response to determining the respective values via the model).

As one example, the configuration may comprise a condition that comprises a start threshold. Satisfaction of the start threshold (e.g., by one or more observed and/or predicted values for a given metric to which the start threshold, where the one or more observed and/or predicted values may be observed and/or predicted over a configured period of time) may indicate that the WTRU is permitted and/or triggered to utilize the model to optimize the one or more metrics. In some examples (e.g., examples in which satisfaction of a condition comprising a start threshold triggers the WTRU to utilize the model), the condition that comprises a start threshold may be referred to as a “first condition” and/or a “start condition.”

As another example, the configuration may comprise a condition that comprises a stop threshold. Satisfaction of the stop threshold (e.g., by one or more observed and/or predicted values for the given metric to which the stop threshold applies, where the one or more observed and/or predicted values may be observed and/or predicted over a configured period of time) may indicate that the WTRU is not and/or is no longer permitted to utilize the model to optimize the one or more metrics (and may further trigger the WTRU to refrain from utilizing the model). In some examples (e.g., examples in which satisfaction of a condition comprising a start threshold triggers the WTRU to utilize the model), the condition that comprises a stop threshold may be referred to as a “second condition” and/or a “stop condition.”

As another example, the associated behavior may comprise autonomously (e.g., without requesting and/or awaiting permission from the network) applying the respective values for the one or more configuration parameters at the WTRU (e.g., by modifying and/or updating current values of the one or more configuration parameters to match the respective values). Furthermore, in this example, the associated behavior may comprise sending an indication to the network that the respective values have been applied at the WTRU.

As another example, the associated behavior may comprise sending a request to the network for respective values to be applied to the one or more configuration parameters. In this example, the associated behavior may further comprise receiving a response from the network indicating that the WTRU is permitted and/or instructed to apply the respective values to the one or more configuration parameters. Furthermore, the associated behavior may comprise, in response to receiving the response from the network, applying the respective values to the one or more configuration parameters.

In addition, the WTRU may monitor for satisfaction of the condition that comprises the start threshold (e.g., by repeatedly observing values for a metric to which the start threshold applies and comparing the observed values for the metric to the threshold).

Furthermore, the WTRU may, in response to determining that the condition that comprising the starting threshold is satisfied, utilize the model to determine and/or predict respective values for the configuration parameters to optimize the one or more metrics (e.g., to achieve respective target values for the one or more metrics).

In response to and/or upon determining/predicting the respective values for the one or more configuration parameters, the WTRU may perform the associated behavior (e.g., as described above).

In the context of the present disclosure, artificial intelligence (AI) may be broadly defined as behavior exhibited by machines (e.g., behavior that may mimic cognitive functions to sense, reason, adapt, and/or act).

Machine learning (ML) may refer to types of algorithms that can create a model to solve a problem based on learning through experience (e.g., in the form of training data) without explicitly being programmed (‘configuring set of rules’). Machine learning may be considered a subset of AI. Different ML paradigms may be envisioned based on the nature of data (e.g., training data) or feedback available to the algorithm that is used to create a given model based on that data and/or feedback. For example, a supervised learning approach may involve learning a function that maps input to an output based on labeled training examples (e.g., training instances), wherein each training example may be a pair comprising input (e.g., one or more feature values) and the corresponding output (e.g., a label). As another example, an unsupervised learning approach may involve detecting patterns in the data (e.g., training data) that lacks pre-existing labels. For example, a reinforcement learning approach may involve performing a sequence of actions in an environment to maximize a cumulative reward. In some solutions, it may be possible to apply machine-learning algorithms using a combination or interpolation of the above-mentioned approaches. For example, a semi-supervised learning approach may use a combination of a small amount of labeled data with a large amount of unlabeled data during training. In this regard semi-supervised learning may be considered to be an approach that falls between unsupervised learning (with no labeled training data) and supervised learning (with only labeled training data).

A given AI/ML model may be trained under certain WTRU-side conditions and network-side conditions, among other possible types of conditions. For example, a WTRU-side condition may be a speed at which a WTRU is moving. As another example, a network-side condition may be related to some network configurations and/or settings that the WTRU may not be aware of, but may nonetheless impact the performance of the given AI/ML model. For example, a Radio Link Failure (RLF) prediction model may perform differently if trained using data that was collected and/or generated when a network was using a certain antenna pattern, beam pattern, power level, or other type of network configuration. Furthermore, a network load that existed when the data used to train the RLF prediction model was collected and/or generated may impact the performance of the RLF prediction model.

Since the WTRU might not be apprised of some of the details of the network-side conditions (and the network may not want to expose some of these details), the network may hide these details by sending (e.g., signaling) one or more associated ID(s) to the WTRU. For example, when data is being collected for training a model, tagging may be performed indicating under which network-side conditions data was collected and/or generated. When the WTRU is being configured to perform the AI/ML-based RLF prediction, the WTRU may be configured to check the consistency between the conditions under which the data used to generate and/or train an AI/ML model and current conditions (e.g., current WTRU-side conditions, current associated ID(s) sent by the network indicating current network conditions/settings, etc.).

In the examples described below, the WTRU may be configured to perform AI/ML based RLF prediction if (and, in some examples, only if) the WTRU has an AI/ML model that was trained and/or generated using data the was collected and/or generated under conditions that are comparable to current WTRU-side and network-side conditions. For example, the network may have sent the current associated ID(s) to the WTRU, the WTRU may have sent an indication that the WTRU has a model that trained and/or generated using data that was collected and/or generated under conditions that are comparable to the current WTRU-conditions and associated ID(s). Based on that comparability, the network may activate the AI/ML functionality (e.g., for performing the AI/ML-based RLF prediction) at the WTRU. If current conditions change such that, while the AI/ML functionality is being used, current conditions are no longer comparable to the conditions under which the training data was collected and/or generated, the WTRU may be configured to stop the AI/ML functionality and start using legacy procedures (e.g., the WTRU may send an indication to the network that the current conditions are no longer comparable and deactivate the AI/ML functionality accordingly, the WTRU may autonomously deactivate the AI/ML functionality in response to determining that the current conditions are no longer comparable, etc.). For example, a change in comparability of current conditions (which may also be referred to as the change in the applicability of the model) may be due to a change in WTRU-side conditions (e.g., changes to a speed of the WTRU) and the WTRU might not have any additional models that were trained using data collected and/or generated conditions comparable to the current WTRU-side conditions. As another example, a change in current network-side conditions may result in a change to the current associated ID(s) that the network provides to the WTRU—and the WTRU might not have any additional models that were trained using data collected and/or generated conditions comparable to the current network conditions as indicated by the current associated ID(s). A change in the current associated ID(s) may occur as a result of the WTRU performing a handover (HO) to a cell that is operating under different network conditions, as a result of the network changing some of the network's configurations without the WTRU performing a HO, or as a result of some other occurrence.

In the context of the present disclosure, the term Life Cycle Management (LCM) is used to describe the overall management aspects of AI/ML models, such as model training, functionality/model identification, model delivery/transfer, model inference operation, functionality/model selection, activation, deactivation, switching, and fallback operation (e.g., decisions by the network (either initiated by the network or initiated by a WTRU and requested by the WTRU to the network), decisions by the WTRU (event-triggered as configured by the network, decided by the WTRU and reported to the network, and/or or WTRU-autonomous either with WTRU's decision being reported to the network or not reported to the network)), functionality/model monitoring, model update, WTRU capability, and/or data collection (e.g., for model training, for monitoring, for inference, etc.)

LCM may be functionality-based LCM or model-ID based LCM.

In functionality-based LCM, the network indicates activation, deactivation, fallback, and/or switching of AI/ML functionality via 3GPP signaling (e.g., RRC, MAC control element (MAC-CE), Downlink Control Information (DCI), etc.). Models may not be identified at the network, and the WTRU may perform model-level LCM. The WTRU may have one AI/ML model for the AI/ML functionality or multiple AI/ML models for the AI/ML functionality.

In model-ID-based LCM, models may be identified at the network. The network and/or the WTRU may activate, deactivate, select, and/or switch individual AI/ML models via model ID.

In functionality-based LCM, the WTRU may choose the AI/ML model to use for a certain functionality (e.g., the network may decide for which functionalities the WTRU may use an AI/ML model, and the WTRU may choose which AI/ML model to use).

In model-ID based LCM, the network may explicitly control which particular AI/ML model is used for a given AI/ML functionality. For example, the WTRU may provide details of AI/ML models and their capabilities to the network, while the network may determine which model to activate for a particular functionality.

The examples described below are applicable to both model-ID based and functionality-based LCM. In other words, the examples described below are related to how the WTRU determines whether the WTRU has a model that is applicable for the associated ID(s). For example, in the case of functionality-based LCM, the WTRU may be configured to and/or receive a request to determine if a given functionality is valid and/or applicable. The WTRU may determine and/or identify which models the WTRU has for the given functionality and may consider the given functionality to be valid and/or applicable if at least one of the models the WTRU has is applicable to the given functionality. In another example, in the case of model-ID based LCM, the WTRU may be configured to and/or receive a request from the network to determine whether a particular model is applicable to the given functionality or not.

An associated ID may be specific to a given functionality, or the associated ID may be applicable to and/or common to more than one functionality.

The WTRU may support several AI/ML models for a given functionality (e.g., models with different prediction time horizons, prediction confidence levels, and/or processing requirements; models trained using data collected and/or generated in different frequencies, cells, locations, times of day, etc.).

A given AI/ML model for a certain functionality may operate in different modes (e.g., with different levels of prediction confidence levels at different prediction time horizons, at different locations, at different frequencies, at different WTRU mobility patterns and/or speeds, etc.).

AI/ML models may be available at the WTRU after being trained beforehand. In addition or alternatively, the WTRU may be provided with an untrained AI/ML model and train that AI/ML model at the WTRU.

In one example, an AI/ML model that is available at the WTRU may have been trained beforehand, and the WTRU may also be configured to train the AI/ML model further (e.g., using data collected and/or generated under conditions (e.g., different frequencies, cells, locations, different times of day, etc.) for comparable to the conditions under which data used to train the AI/ML model beforehand was collected and/or generated. Training the AI/ML model further in this manner may increase the confidence level and/or the prediction time horizon for different WTRU speeds and for other types of conditions.

In another example, an AI/ML model that is available at the WTRU may not have been trained beforehand or may have been trained using data collected and/or generated under an initial set of WTRU-side and/or network-side conditions. In this example, the WTRU may be configured to train the AI/ML model (e.g., using data collected and/or generated under conditions that do not match the initial set of WTRU-side and/or network-side conditions).

In some cases, the WTRU may be configured with some configuration and/or inputs for performing an AI/ML functionality (e.g., an inference) using an AI/ML model. For example, for radio signal level prediction, the WTRU may be configured with a certain number of beams/cells to measure to determine the prediction. In some cases, the WTRU may include one or more indications of the configuration and/or input as part of capability information included in a capability report. In other cases, the WTRU may send one or more indications of the configuration and/or input to the network after a capability request (e.g., based on an explicit network request, if the WTRU is configured to do AI/ML-based predictions or values for metrics and the WTRU has determined that the WTRU lacks the configuration and/or input, etc.).

Examples described herein are agnostic to the type of AI/ML model and/or AI/ML technique used by the WTRU (e.g., the algorithm used to generate an AI/ML model; the mechanism used to represent the AI/ML model, such as neural network or what kind of neural network in terms of depth and/or parameters and/or weights of the neural network; etc.), the origins of the AI/ML model (e.g., the WTRU vendor, an operator of the WTRU, the network vendor, etc.), and/or how and/or where the training of the AI/ML model is done (e.g., training data used for training the AI/ML model, where the training of the AI/ML model is performed, whether the training of the AI/ML model is performed offline and/or or online, etc.). However, the model may be trained based on historical observation of one or more WTRUs'actual measurements made under different WTRU-side and network-side conditions (e.g., during certain times of day, during certain days of the week, at different locations, at different WTRU mobility patterns and/or speeds, under different network-side conditions that are visible to the WTRU such as frequency and/or bandwidth, under different network configurations which may be visible to the WTRU as a network configuration index that is provided by the network at the time of training or when the data used for training is collected and/or generated, etc.).

The terms “data,” “measurements,” “report,” and/or “results” may, in some instances, be used interchangeably herein.

The terms “indication,” “information,” and/or “message” may, in some instances, be used interchangeably herein.

The terms “functionality” and/or “procedure” may, in some instances, be used interchangeably herein.

The terms “execute,” “apply,” and/or “perform” may, in some instances, be used interchangeably herein.

The terms “legacy” and/or “non-AI/ML” may, in some instances, be used interchangeably herein.

The term “supported functionality” may be used herein to refer to AI/ML functionalities that the WTRU is capable of performing. However, in some instances, even if the WTRU is capable of performing a given AI/ML functionality, the given AI/ML functionality might not be activated at the WTRU. For example, the WTRU might not have a model that is trained for the current WTRU-side and/or network-side conditions, the WTRU may have a model that is not trained and/or ready to be used, and/or the WTRU might not even have a model for performing the given AI/ML functionality (e.g., even if the WTRU is capable of the performing the AI/ML functionality with respect to hardware and software included in the WTRU).

As used herein, the term “applicable functionality” refers to AI/ML functionality for which the WTRU has at least one model that is trained for current WTRU-side and network-side conditions and/or has been tested to work under conditions comparable to the current WTRU-side and network-side conditions. Given that the WTRU has the at least one model in this scenario, the AI/ML functionality may be activated. For instance, the WTRU may use the at least one model to make inferences instead of and/or or in addition to non-AI/ML techniques. For example, the WTRU may utilize the at least one model to predict signal levels of serving and/or neighbor cells and/or beams instead of (or in addition to) making actual measurements on those signal levels of serving and/or neighbor cells and/or beams). In some instances, the term “applicable functionality” as used herein may also be used to refer specifically to functionalities for which the WTRU also has a configuration for performing the inferences (in addition to having the at least one model that is trained for current WTRU-side and network-side conditions and/or has been tested to work under conditions comparable to the current WTRU-side and network-side conditions).

As used herein, the term “activated functionality” refers to functionalities for which the WTRU is already using an AI/ML model to make inferences (e.g., using an AI/ML model to predict signal levels of beams and/or cells).

As used herein, the term “configured functionality” refers to functionalities with which the WTRU has been configured (e.g., at least to perform functionality applicability determination). Some configured functionalities may or may not be applicable, while some applicable functionalities may or may not be activated.

As used herein, the terms “inactive,” “inactivated,” “non-active,” “non-activated,” “dis-active,” and “dis-activated” may, in some instances, be used interchangeably.

While the examples described below may discuss predictions based on AI/ML models, the examples described below may also apply to other forms of prediction that do not use AI/ML models (e.g., certain methods for time series forecasting, certain interpolation methods, etc.).

As used herein, the terms “parameter” and “Information Element (IE)” may, in some instances, be used interchangeably.

Some examples discussed may refer to a WTRU being capable of optimizing a certain parameter. In such examples, this means that the WTRU may use an AI/ML model to determine a value for a configuration parameter other than a default value and/or or a current value for that configuration parameter (e.g., to optimize a certain KPI).

As used herein, the terms “KPI,” “KPI metric,” and “KPI level” may, in some instances, be used interchangeably.

In one example, a WTRU is provided with information regarding different KPIs (e.g., throughput, latency, reliability, etc.) and the configuration parameters that may affect the different KPIs. For instance, the WTRU may be provided with a relation that associates each given KPI with a respective set of configuration parameters that may affect the given KPI.

In one example, the information regarding the different KPIs and the configuration parameters that may affect the different KPIs may comprise one or more priority-level and/or impact-level groupings. For instance, a priority-level and/or impact-level grouping may group the configuration parameters that may affect a given KPI into a plurality of bins and/or categories (e.g., a high-impact bin and/or category, a medium-impact bin and/or category, and/or a low-impact bin and/or category, among other possible types of bins and/or categories).

In one example, a relation between a KPI and one or more configuration parameters may be specified by an industry standard (e.g., a 3GPP standard).

In one example, a relation between a KPI and one or more configuration parameters is provided to the WTRU in a dedicated and/or groupcast and/or broadcast fashion (e.g., in an RRC reconfiguration message).

In one example, a given configuration parameter that is being configured (e.g., at an RRC level, at a PDCP and/or bearer level, at a MAC level, etc.) may contain information that indicates with which KPI(s) a configuration parameter is associated (e.g., a relation). For example, in current RRC specifications, a configuration parameter may have a “Need code” associated therewith that indicates additional information about the configuration parameter, such as whether the configuration parameter is mandatory or optional, whether the configuration parameter is maintained or released if the WTRU receives an RRC reconfiguration that does not contain that configuration parameter, one or more conditional associations with other configuration parameters and/or settings, etc. A similar approach may be taken to indicate and/or specify with which KPI(s) a given configuration parameter is associated and/or an impact level of that configuration parameter on the KPI, among other possibilities.

In one example, the KPIs may be specified at the WTRU level (e.g., total and/or average and/or mean WTRU throughput over a given averaging duration, average and/or min and/or max and/or mean latency of packets over a given average duration—for instance, at a PDCP level according to a time between a packet arrival time at the PDCP and discard time due to reception of an Acknowledgement (ACK) for the packet at the PDCP and/or or lower layers, etc.).

In one example, the KPIs may be specified at a bearer level and/or a logical-channel level.

In one example, the KPIs may be specified at a given protocol-layer level (e.g., an RRC level, a PDCP level, a MAC level, etc.)

The relation between the KPIs and the configuration parameters may include other information such as location (e.g., of cells, group of cells, tracking areas, Public Land Mobile Networks (PLMNs), etc.), range of serving-cell(s) signal levels, time duration of the day, WTRU speeds, frequency layers, current network congestion level—for instance, a congestion level explicitly indicated to the WTRU and/or implicitly determined by the WTRU, current network energy saving state—for instance, as explicitly indicated to the WTRU and/or implicitly determined by the WTRU, associated ID, average Uplink/Downlink (UL/DL) grant levels and/or values, etc., where the relation is valid.

The examples above involve scenarios in which relationships between configuration parameters and the KPIs that those configuration parameters may affect are known beforehand, and possibly in which the impact and/or priority levels of the different configuration parameters for the KPIs are also known beforehand.

In one example, WTRUs may help the network identify these relationships between KPIs and configuration parameters. Several approaches for using WTRUs to help the network identify these relationships are described below.

In one example, a WTRU may be configured with information about KPIs (e.g., but without any information about the related configuration parameters) and with some absolute and/or relative thresholds associated with the KPIs to be monitored. If it is to be determined which configuration parameters affect the throughput of a bearer, then the WTRU may be provided with a relative (e.g., percentage) reduction and/or increase in throughput that the WTRU is to monitor within a given time duration after a change has been made to the value of a certain configuration parameter (e.g., specific to the bearer that is being monitored, at a WTRU level and/or a MAC level, etc.). The WTRU may log information regarding this monitoring and send the logged information to the network (e.g., periodically, on request, when a certain number of such changes have occurred—for instance, within a given observation period, etc.). The network may use such logged information gathered from a multitude of WTRUs over a given time period and/or area to train a network-side model to determine relationships between KPIs and configuration parameters.

In one example, a WTRU-side model may be used to determine relationships between KPIs and configuration parameters. For instance, the WTRU may log information as described above with respect to the network-side model and may send the logged information to a server and/or entity. That server and/or entity may use the logged information to train the WTRU-sided model and send the WTRU-side model to the WTRU once the training is finished (e.g., with or without the radio access network and/or CN being aware of the model transfer).

In one example, a WTRU-side model may, at any given time, consider current WTRU-side conditions such WTRU speed, the current serving cell(s) radio signal level, the current cell and/or tracking area, the UL/DL grant allocation history for the WTRU, and/or other network related information that the WTRU can either gather (e.g., implicitly) or receive (e.g., explicitly) from a network (e.g., network congestion level, network energy saving state, associated ID, etc.). The WTRU-side model may predict which configuration parameters are likely to affect the KPIs (and, in some examples, also predict impact levels of impact for the different configuration parameters).

In one example, the WTRU-side model may be provided with the different configuration parameters to consider (e.g., from the network), and may be configured to classify the different configuration parameters into impact levels.

In some examples, a two-sided model may be used. For instance, in one example, a network-side model may identify a certain subset of the configuration parameters while a WTRU-side model may identify a remainder of the configuration parameters. In another example, one of the WTRU-side model or the network-side model may identify the configuration parameters, while the other of the WTRU-side model or the network-side model may identify impact levels for the configuration parameters.

In examples the above, AI/ML LCM has been described at a functionality level and/or at model level. In the examples below, enhancements for supporting LCM at the level of KPI and/or configuration-parameter optimization are provided.

In one example, a WTRU may indicate to the network that the WTRU is capable of AI/ML-based optimization of one or more KPIs and/or AS/NAS configuration parameters.

In one example, a WTRU may indicate to the network that the WTRU is capable of AI/ML-based optimization of one or more KPIs and/or AS/NAS configuration parameters this as a response to an RRC/NAS reconfiguration message. For instance, the WTRU may send an RRC/NAS response message (e.g., reconfiguration complete message) that indicates which of the configured parameters the WTRU is capable of optimizing.

In one example, the WTRU may indicate the KPIs that it can optimize in addition to (or as an alternative to) the configuration parameters the WTRU can optimize. For instance, if there is a relation between a KPI and the configuration parameters in a list (e.g., identified via a deterministic approach and/or via an AI/ML based approach as described above), the WTRU may indicating the capability of the WTRU to optimize a given KPI implicitly by indicating the configuration parameters that the is capable of optimizing

In one example, the WTRU may use a WTRU-capability like signaling to indicate the KPIs and/or the AS/NAS configuration parameters that the WTRU is capable of optimizing.

In one example, the WTRU may use a WTRU-assistance-information (UAI) like signaling to indicate the KPIs and/or the AS/NAS configuration parameters that the WTRU is capable of optimizing.

In one example, the WTRU may receive an explicit request from the network (e.g., gNB, AMF, Location Management Function (LMF), or some other network function) requesting the capability of the WTRU to optimize one or more specified KPIs and/or AS and/or NAS configuration parameters, and the WTRU may respond with an indication of which of those KPIs and/or AS/NAS configuration parameters the WTRU is capable of optimizing.

In one example, the WTRU may have different models for performing optimizations of different KPIs and/or configuration parameters.

In one example, the WTRU may have several models for doing the optimization of a given KPI and/or configuration parameter. For example, the WTRU may have two models for optimizing a given KPI and/or configuration parameter. One of the two models is a complex model that has a high accuracy (or prediction-confidence level), while the other of the two models may be a simpler model that has a low accuracy (or prediction confidence level). The complex model may be preferable in cases in which the WTRU has a high battery level, while the simpler may be more suitable for cases in which the WTRU has low battery level.

In one example, the WTRU may indicate the details of each individual AI/ML model in relation to the optimization of the one or more KPIs and/or configuration parameters, including confidence level, model identity, model complexity (e.g., processing requirements, etc.).

In the examples described below, an AI/ML model for a KPI and/or configuration parameter may refer to a model that may be used to determine an optimal value for a configuration parameter associated with the KPI to achieve a target value for a metric (e.g., to reach a certain target KPI level).

Even if a WTRU may have a model or several models for doing an optimization of certain KPIs and/or configuration parameters, these models might, at times, not be usable because the models may trained using data that was collected and/or generated under given conditions (e.g., certain WTRU-side and network-side conditions) and may not be suitable to be used under conditions that are not comparable to (e.g., identical or similar to) the those given conditions.

In one example, the WTRU may receive a request from the network regarding the applicability of an AI/ML model for the optimization of one or more KPI(s) and/or AS and/or NAS configuration parameters. In this example, the applicability of an AI/ML model may refer to a particular model or to any model that is applicable to the one or more KPI(s) and/or AS and/or NAS configuration parameters. For instance, the network may send the request to ask for information regarding whether the WTRU has any applicable AI/ML model for optimizing for a given KPI. In another example, the network may send the request ask for information regarding whether a given AI/ML model for optimizing a given KPI is currently applicable (e.g., based on the detailed capability information that the WTRU may have provided as discussed above) or which of the AI/ML models are currently applicable.

In one example, the request may be an immediate request. In this example, the WTRU may determine the applicability (e.g., in accordance with examples described further below) and send the requested information in response (e.g., in a report). When the WTRU behaves as described in this example, this behavior may be referred to herein as reactive applicability determination and/or reporting.

In one example, the request may be a proactive and/or monitoring request. In this example, the WTRU may monitor the applicability (e.g., in accordance with examples described further below) and send a message (e.g., a report) when and/or if a model at the WTRU for optimizing the given KPI and/or configuration parameters becomes applicable. When the WTRU behaves as described in this example, this behavior may be referred to herein as proactive applicability determination and/or reporting.

In one example, the request from the network regarding the applicability of an AI/ML model may comprise a combination of the two preceding examples. For instance, the WTRU may check (e.g., immediately) whether there is an applicable model for optimizing the KPI and/or configuration parameters (or if the request indicates a specific AI/ML model, whether the specific AI/ML model is applicable). If there is an applicable model at the WTRU (e.g., if the request indicates a specific AI/ML model and the specific AI/ML model is applicable), the WTRU may send an applicability report (e.g., immediately). Otherwise, the WTRU may start monitoring the applicability and send an applicability report when and/or if a model for the given KPI and/or configuration parameters (or the AI/ML model specified in the request) becomes applicable.

In one example, the request (e.g., applicability request) may be a dedicated message to the WTRU (e.g., an RRC message, an NAS message, a MAC CE message, a DCI message, etc.).

In one example, the request (e.g., applicability request) may be a broadcast message (e.g., an IE in a system information block (SIB)).

In one example, the request (e.g., applicability request) may be a groupcast message to a subset of WTRUs.

In one example, the request (e.g., applicability request) may be a paging message to one or more WTRUs (e.g., a paging Radio Network Temporary Identifier (RNTI), a group paging RNTI, etc.).

In one example, the request (e.g., applicability request) may regard the full set of KPIs and/or configuration parameters (e.g., comprising each KPI and/or configuration parameters that the WTRU has indicated that the WTRU is capable of optimizing using an AI/ML model in a capability report).

In one example, the request (e.g., applicability request) may regard one or more KPIs and/or configuration parameters. For example, the request may include a list of the KPIs and/or configuration parameters for the WTRU to consider when making an applicability determination (e.g., such that the WTRU may do an applicability determination of the AI/ML models associated with the KPIs and/or configuration parameters). In another example, the request may include a list of the KPIs and/or configuration parameters that the WTRU is instructed not to consider when making an applicability determination (e.g., KPIs and/or configuration parameters that are included in the list may not be considered, while KPIs and/or configuration parameters not included in the list may be considered).

In one example, the request (e.g., applicability request) may indicate a first set of KPIs and/or configuration parameters. In this example, the WTRU may be configured to perform reactive applicability reporting for AI/ML models that are applicable to KPIs and/or configuration parameters in the first set. Furthermore, the request may indicate a second set of KPIs and/or configuration parameters. The WTRU may be configured to perform proactive reporting for AI/ML models that are applicable to KPIs and/or configuration parameters in the second set. Thus, in this example, a single applicability request may be used to configure reactive reporting for the AI/ML models of some KPIs and/or configuration parameters (e.g., those included in the first set) and proactive reporting for other KPIs and/or configuration parameters (e.g., those included in the second set).

In examples described below, the phrase “a WTRU having an applicable KPI and/or configuration parameter” may refer used to a WTRU having one or more AI/ML models that are trained to optimize a certain KPI and/or configuration parameter.

In one example, the request (e.g., applicability request) from the network includes one or more associated IDs related to a network configuration that the WTRU may consider when performing an applicability determination.

In one example, the associated IDs may be included in the request. In another example, the associated IDs may be provided in a separate message prior to the request.

In one example, the associated IDs may be common for each of the AI/ML models for the KPIs and/or configuration parameters.

In one example, the associated IDs may be specific to the AI/ML models for a given KPI and/or configuration parameter and/or a subset of the KPIs and/or configuration parameters. For example, the request (or the prior message that provided the associated IDs to the WTRU) may indicate one associated ID for throughput-related KPIs, another associated ID for latency-related KPIs, another associated ID for buffer-level-management-related KPIs, etc.

In one example, the WTRU may determine that an AI/ML model for a KPI and/or configuration parameter is applicable if one or more of the following conditions are satisfied: (i) there is at least one AI/ML model for optimizing the KPI and/or configuration parameter; and/or (ii) there is at least one AI/ML model that satisfies one or more of the following: (a) the at least one AI/ML model has been trained for the current WTRU-side conditions (e.g., current WTRU speed), (b) the at least one AI/ML model has been trained for the indicated network conditions (e.g., the network conditions corresponding to indicated associated ID(s)), and/or the at least one AI/ML model is expected to perform to an indicated level (e.g., if the request specifies one or more performance-level thresholds, such as performance-level thresholds for confidence level, accuracy, etc.).

After the WTRU performs the applicability determination for the one or more indicated KPIs and/or configuration parameters in the applicability request, the WTRU may send an applicability report to the network.

In one example, the applicability report may comprise an RRC message (e.g., a new RRC message which may comprise additional IEs included in an existing RRC message such as an RRC Reconfiguration Complete message or some other type of existing RRC message).

In one example, the applicability report may comprise an NAS message (e.g., which concerns NAS-related KPIs and/or configuration parameters).

In one example, the applicability report may comprise a MAC CE.

In one example, the applicability report may comprise Uplink Control Information (UCI).

In one example, the applicability report may be (or comprise) a bitmap (e.g., in which a “0 ” may indicate non-applicability and/or a “1” may indicate applicability, or vice versa). In one instance, the ordering of the bitmap may correspond to an order in which the KPIs and/or configuration parameters were indicated (e.g., signaled) in the request.

In one example, the applicability report may comprise identities and/or names of the KPIs and/or configuration parameters functionalities that are applicable. For example, the different KPIs may be assigned a local and/or global ID (e.g., an integer value which may be indicated in the request message or prior to the request message) and the WTRU may include a list of the IDs and/or names of the KPIs that are applicable.

In one example, the applicability report may comprise the identities and/or names of the KPIs and/or configuration parameters that are not applicable.

In one example, the identities and/or names of both the applicable and non-applicable KPIs and/or configuration parameters may be included in the applicability report. For instance, the applicability report may include two lists—a first list for the applicable KPIs and/or configuration parameters and a second list for the KPIs and/or configuration parameters.

The applicability request message may include an indication of whether the WTRU is to report applicable KPIs and/or configuration parameters, non-applicable KPIs and/or configuration parameters, or both.

In one example, if non-applicable KPIs and/or configuration parameters are to be indicated in the applicability report, the WTRU may include one or more of the following reasons (e.g., cause values) for non-applicability along with the identity and/or name of the KPI and/or configuration parameter: (i) there is no model available for the KPI and/or configuration parameter, (ii) there is no trained model available for the KPI and/or configuration parameter (e.g., a model is available, but has not yet been trained), (iii) there is a model available for the KPI and/or configuration parameter and the model has been trained, but not for the current network conditions (e.g., as indicated by the associated ID(s)), (iv) there is a model available for the KPI and/or configuration parameter and the model has been trained, but not for the current WTRU conditions (e.g., current WTRU speed).

In one example, the WTRU may receive an indication and/or configuration from the network that instructs the WTRU to activate the optimization of a KPI and/or associated configuration parameter based on an AI/ML model (e.g., an activation command). For instance, this indication and/or configuration may be based on the capability and/or applicability report the WTRU provided to the network earlier.

The activation command may be an RRC message, a NAS message, a MAC CE, or a DCI, and may comprise the name and/or identity of the KPI(s) and/or configuration parameter(s) to be optimized.

In one example, the activation command may trigger an immediate activation of an optimization process. The optimization process is described further below.

In one example, the WTRU may be provided with additional start conditions for activating and/or starting the KPI and/or configuration parameter optimization. For example, the WTRU may be provided with one or more thresholds associated with the KPI that the WTRU is to monitor. When the WTRU determines that the KPI satisfies one or more conditions that comprise the one or more thresholds (e.g., one or more observed and/or determined values for the KPI fall below/above a given threshold), the WTRU may start the AI/ML-based optimization of the KPI by tuning the values for the one or more configuration parameters. The start conditions may be provided as part of the activation command or pre-configured beforehand.

In one example, the thresholds that the start conditions comprise may be absolute thresholds (e.g., which may apply to KPIs such as throughput, latency, etc.) such that a single observed value that is beyond an absolute threshold may fail to satisfy a start condition that comprises the threshold).

In one example, the thresholds may be relative thresholds that are to be applied to groups of values over a given time duration. For instance, a relative threshold that applies to throughput may be compared to values of throughput observed over a given time period such that a start condition comprising the relative threshold may be considered not to be satisfied if the throughput drops by a certain percentage from a current value (or some default value) for a series of values observed during a given time duration.

In one example, the WTRU may also be provided with one or more target values (e.g., an optimization target level and/or threshold). The WTRU may consider the KPI to be optimized when the one or more target values are reached. For example, the target value may indicate be reached when a current value of a given KPI to matches (e.g., equals and/or exceeds and/or falls below) the target value.

In one example, the WTRU may be provided with Time-To-Trigger (TTT) values for determining the start and/or stop conditions are satisfied (which may be the same values or different values). For example, the WTRU may wait until the start conditions are fulfilled for at least the TTT duration associated with the start conditions before starting the optimization process. Similarly, the WTRU may be configured to wait until the ending thresholds are satisfied for at least the TTT duration associated with the stop conditions before considering the optimization to be ended.

The examples above describe scenarios in which the WTRU is monitoring the KPIs and determining to start the optimization when the values of the KPIs have satisfied the start conditions and/or thresholds. This is a reactive approach and may not be sufficient in some cases where a fast action is to be made (e.g., cases where it is acceptable to let the KPI fall below and/or above the required levels for no more than a short period of time).

In one example, the WTRU may start the optimization proactively, even before the KPIs have satisfied the start conditions, based on a prediction that the start conditions will be satisfied within a short (e.g., configured) time duration with a confidence level above a configured threshold. For example, the WTRU may have an AI/ML model that uses the current KPI levels, previous KPI levels, historical KPI levels when the WTRU had a similar WTRU-side conditions and the network had similar network-side conditions and predict what the value of the KPI is expected to be for a certain time in the future. If the configured KPI-optimization start conditions and/or thresholds are expected to be satisfied, then the WTRU may start the optimization process (e.g., even if the current KPI levels do not satisfy the start conditions).

In one example, the WTRU may be configured to optimize a KPI and/or configuration parameter and apply one or more of the following behaviors after determining and/or predicting an updated value (e.g., a new value) for the configuration parameter(s): (i) modifying the configuration parameter's value to the predicted and/or determined updated value, without informing the network, (ii) modifying the configuration parameter's value to the predicted and/or determined updated value and informing the network (e.g., of the updated value, a reason for a change, etc.), and/or (iii) requesting that the network modify the value of the configuration parameter to the predicted and/or determined updated value (e.g., in a request that includes the updated value and reason for the change) and apply the modification only upon receiving a confirmation from the network.

The behavior may be the same for each configuration parameter that the WTRU can modify, may be common for each configuration parameter that is associated with the same KPI, or may even be different for two configuration parameters that are associated with the same KPI (e.g., for KPIx, the WTRU may be configured to be able to modify configuration parameters x1, x2, and x3 and to be able to modify the value of x1 without informing the network, able to modify the value of x2 but ay have to inform the network and may not be able to modify the value of x3 without a confirmation from the network, etc.)

In some cases, if there are a multitude of configuration parameters to be modified and some of those configuration parameters are not to be modified until confirmation from the network is received, while others of those configuration parameters can be modified without confirmation form the network, the WTRU may be configured to wait for the confirmation regarding the configuration parameters that are not to be modified without confirmation before applying the changes regarding those configuration parameters. This is to avoid scenarios in which the network may reject the change request for the configuration parameters that are not to be modified without confirmation and the WTRU may have nonetheless already applied the changes to the configuration parameters that can be modified without confirmation, resulting in unexpected or even worse performance than was observed before the changes were applied. The WTRU may be configured to inform the network about the other related configuration parameter changes that the WTRU may modify without confirmation from the network. For the example given above regarding the three configuration parameters x1, x2, and x3, the WTRU may, in the request to change the value of x3, include an indication that informs the network (e.g., by indication “if the change of value of x3 is confirmed, the WTRU will also change the value of x2 and x1” along with changing the values for x1 and x2).

The configuration of the above behavior for the different configuration parameters described above can be indicated to the WTRU as part of the activation of an optimization of a given KPI and/or configuration parameter. In addition or alternatively, the WTRU may be preconfigured with the behavior even before activation of the optimization.

In one example, the WTRU uses an AI/ML model to predict the value(s) of one or more of the configuration parameters associated with the concerned KPI that may be being optimized to reach a target value (e.g., a desired KPI level) as discussed above.

In one example, if there are multiple configuration parameters associated with a KPI, the WTRU may use a stepwise approach in which the WTRU may first attempt to predict whether the desired KPI level may be reached by changing a single configuration parameter. If a change of a single parameter is predicted not to result in the desired KPI level, the KPI may next attempt to predict whether the desired KPI level may be reached by changing another one of the configuration parameters, and so forth, until the WTRU predicts that the desired KPI level may be reached. The order in which the WTRU the makes these predictions based on the configuration parameters may be, for example, based on the impact levels of the configuration parameters for the KPI (with which the WTRU may have been configured along with the KPI-to-configuration-parameter relations, as discussed above). Further, the WTRU may consider more than one configuration parameter at once in the optimization process (e.g., consider a configuration parameter with a highest impact level and, if changing that configuration parameter's value is not predicted to result in the desired KPI level, consider that configuration parameter along with the configuration parameter with the second-highest impact level, and so on).

In one example, the WTRU may be configured to do “what if” scenario simulations to determine whether the predicted configuration parameter changes would have provided the desired KPI level before changing the configuration parameter values. For instance, consider the NR beam failure detection and recovery procedure performed by the MAC sublayer. A simplified description of the mechanism used for this procedure is provided in the following paragraph.

When the PHY sublayer detects that the RSRP of the reference signal of the serving beam goes below a certain threshold, the PHY sublayer may send a beam failure instance (BFI) indication to the MAC sublayer. The MAC sublayer may start a timer upon receiving the BFI and increment a counter by one for each BFI received. When the counter reaches a certain threshold (e.g., when BFI_COUNTER>=beamFailureInstanceMaxCount) before a timer expires, the MAC sublayer may trigger Beam Failure and may start a recovery procedure.

A higher value for the counter (e.g., beamFailureInstanceMaxCount), for example, may indicate that the WTRU may have to wait a longer time to perform beam recovery.

For example, consider a scenario in which an AI/ML model for beam failure recovery optimization has predicted to use a beamFailureInstanceMaxCount value of five—which is smaller than the beamFailureInstanceMaxCount value that the WTRU is configured to use by default and/or as an initial value (e.g., ten). The WTRU may, for a given observation duration, observe that there are no or very few instances in which the BFI_COUNTER has reached five without also reaching ten. This observation of the WTRU may confirm that the recovery could have started earlier as proposed by the AI/ML model, so the WTRU may decide to change the value of beamFailureInstanceMaxCount value to five. On the other hand, during the observation period, if there are several instances in which the BFI_COUNTER has reached a value between five and none, but not ten (beam recovery would have been triggered prematurely if the beamFailureInstanceMaxCount value was set to five), then the WTRU may decide not to change the value of beamFailureInstanceMaxCount to five. The WTRU may be configured to determine whether the predicted value should be used or not (e.g., the WTRU may be configured with the percentage of instances for which the prediction is wrong and use that percentage to conclude that the prediction is or is not valid).

In one example, it may not be possible to perform such a “what if” scenario simulation because the change of the value of a configuration parameter may impact on how the network will respond (e.g., change of retransmission timers, polling indication frequency for the reception of status reports indicating and/or confirming the reception of packets at a given I2 and/or L3 protocol layer, etc.). In such cases, the WTRU may be configured to do a temporary change of the value for a configured time duration and monitor the KPI during that time duration to see if the target values (e.g., KPI levels) are achieved. If the target values are achieved, the WTRU may retain the change. Otherwise, the WTRU may revert to a default and/or initial and/or previous values for the configuration parameters).

In one example, the WTRU may be configured to not do any checks within an observation period and use the predicted values for the configuration parameters from an AI/ML model (e.g., if the AI/ML model has been rigorously tested and has been shown to give satisfactory predictions under comparable WTRU-side and/or network-side conditions such as location, time of day, etc.).

Once the WTRU has determined and/or predicted new value(s) of configuration parameter(s) to optimize the KPI according to any of the examples above, the WTRU may perform the associated configured behavior for the change of the configuration parameter(s) value(s) that was discussed above (e.g., by modifying without informing the network, modifying with informing the network, requesting permission from the network for the value to be modified, etc.). As described above, the behavior may be the same for each configuration parameter in question or may be different. For example, the WTRU may have elected to change values of configuration parameters x1 and x2, and the WTRU may change the value of x1 without informing the network, but the WTRU is configured to wait until receiving a confirmation regarding the value of x2.

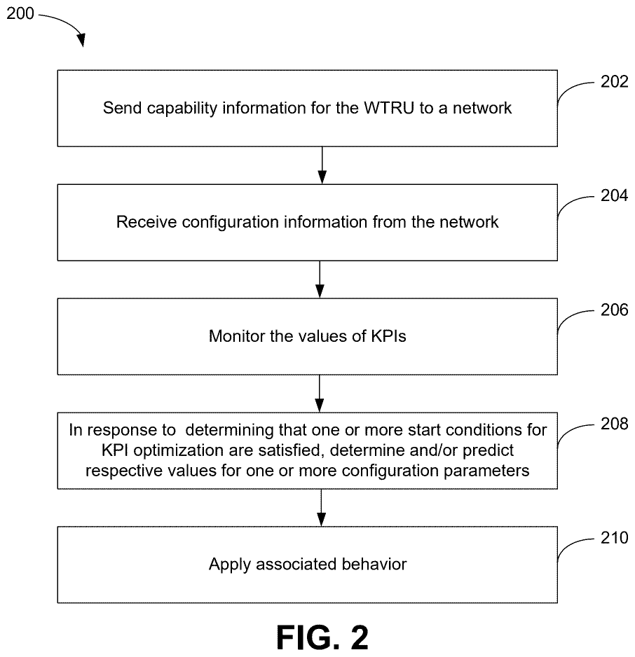

FIG. 2 illustrates an example procedure 200 that may be performed by a WTRU in accordance with examples described herein. In some examples, additional actions not shown in FIG. 2 may be performed and/or some actions depicted in FIG. 2 may be omitted. Furthermore, in some examples, some of the actions depicted in FIG. 2 may be performed in orders other than the order depicted in FIG. 2 and/or may be performed concurrently (e.g., in parallel).

At 202, the WTRU may send capability information to a network. The capability information may comprise, for example, indicia of KPIs and/or configuration parameters that the WTRU is capable of optimizing via one or more AI/ML models, WTRU-side and/or network-side conditions for applicability of the one or more AI/ML models, and/or performance and/or accuracy levels, among other possible types of capability information.

At 204, the WTRU may receive configuration information from the network. The configuration information may comprise, for example, indicia of one or more relations between KPIs and configuration parameters, KPIs to be optimized and/or configuration parameters to be optimized, start conditions and/or thresholds for triggering optimizations, parameter relationships and/or restrictions (e.g., value ranges and/or initial values for the configuration parameters), associated behavior for determining new values for configuration parameters, etc.).

At 206, the WTRU may monitor the values of one or more KPIs.

At 208, the WTRU may, in response to a determination that one or more start conditions for KPI optimization are satisfied, determine and/or predicted respective values for one or more configuration parameters (e.g., using an AI/ML model).

At 210, the WTRU may apply associated behavior. Applying associated behavior may comprise, for example, modifying a configuration value without informing the network, modifying a configuration value and informing the network of the modification, requesting permission from the network to change a value for a configuration parameter, etc.

Further examples based on the example set of actions 200 are explained provided below.

At 202, the WTRU may exchange capability information with the network, where the WTRU indicates the WTRU's capabilities regarding the optimization of one or more of AS and/or NAS configuration parameters for optimizing one or more KPIs.

As discussed above, the signaling for the capability exchange may be based on a WTRU-capability-exchange framework, an RRC reconfiguration, and/or WTRU-Assistance information. Further, the signaling for the capability exchange may be based on a request/response basis in which the network may request that the WTRU provide capability information regarding specific KPIs and/or configuration parameters that the WTRU is capable of optimizing.

At 204, the WTRU may receive a configuration for performing KPI and/or configuration parameter optimization. For instance, based on the capability information, the network may configure the WTRU to optimize certain KPIs and/or configuration parameters.

The relations between the KPIs and the configuration parameter(s) related to those KPI may be provided at 204 or by an earlier action (e.g., that precede 202), such as by an exchange of dedicated RRC and/or NAS configuration messages specified in 3GPP specifications or in some other manner.

The WTRU may be configured with a subset of the configuration parameters that the WTRU is permitted to modify (e.g., the KPI-to-configuration parameter relation(s) may contain ten configuration parameters, but the WTRU may be configured to be able to modify just two of the ten configuration parameters).

The WTRU may be configured with start conditions and/or thresholds for starting the optimization of the KPIs (e.g., start conditions stipulating that KPI values fall below a certain level, start conditions stipulating KPI changes by a certain relative and/or percentage amount have occurred within a given time, etc.).

In one example, configuration information provided to the WTRU may comprise, for example, indicia of one or more ranges of values the different configuration parameters are permitted to take, configuration parameters that are associated with a certain KPI and that can be modified concurrently, and/or restrictions that apply to the values of certain configuration parameters depending on the values of other configuration parameters.

In one example, associated behavior to be performed in response to determining to change value(s) of configuration parameter(s) value(s) may comprise a number of operations, such as: autonomously changing a value of a configuration parameter without informing the network, autonomous changing a value of a configuration parameter and informing the network of the change, and/or informing the network about the determined value(s) and applying a change only upon confirmation from the network.

At 206, the WTRU may monitor values of the KPIs (e.g., to determine if and/or when parameter optimization is to be performed). In this example, determining whether configuration parameter optimization is to be performed may be based on actual KPI values that are observed and/or on predicted KPI values. For instance, the WTRU may predict KPI values using an AI/ML model (e.g., with a high level of confidence) and may therefore predict that the signal level of the serving cell (i) is going to be below a certain level within a given time duration in the future and (ii) is going to stay below the certain level for a certain time duration. Based on this prediction about the signal level of the serving cell, the WTRU may also predict that the configured KPI (e.g., throughput) will fall below a configured KPI threshold (which may be specified in a start condition) for starting the optimization. As such, instead of waiting for the KPI to drop below the configured KPI threshold, the WTRU may proactively activate the AI/ML model for the configuration parameter optimization and modify the corresponding configuration parameter value(s) (or request that the network change the corresponding configuration parameter values).

At 208, the WTRU may determine and/or predict one or more optimal configuration parameter value. For instance, in response to determining that one or more start conditions for the KPI and/or configuration parameter optimizations are satisfied (or are predicted to be satisfied), the WTRU may determine and/or predict respective new values for the one or more configuration parameters related to the KPI.

If an AI/ML model is used to predict and/or determine that a KPI optimization is to be performed, the AI/ML model that is used for that prediction may be the same as, or different from, the AI/ML model for determining the optimal configuration parameter values.

At 210, the WTRU may apply associated behavior based on the configuration parameter value change. For instance, for the one or more configuration parameters that were determined to be modified at 208, the WTRU may one or more of the following behaviors: (i) modifying a configuration parameter's value to match a predicted and/or determined value for the configuration parameter without informing the network, (ii) modifying the configuration parameter's value to match the predicted and/or determined value, and informing the network (e.g., of the new value, a reason for a change, KPI values, etc.), and/or (iii) requesting that the network modify the value of the configuration parameter to match the predicted and/or determined value (e.g., including the new value and reason for a change in the request and applying the modification in response to receiving a confirmation from the network.

The associated behavior may be the same for each configuration parameter the WTRU can modify, or may be common for each configuration parameters that is associated with the same KPI, or may be different for two configuration parameters that are associated with the same KPI (e.g., for KPIx, the WTRU may be configured to be able to modify configuration parameters x1, x2, and x3, to be able to modify the value of x1 without informing the network, to able to modify the value of x2 but inform the network and not able to modify the value of x3 without a confirmation from the network).

In one example, the process of the AI/ML-based optimization may be categorized into the following sub parts.

One of these subparts refers to KPIs-to-configuration-parameters relations. These relations may be generated in a deterministic way and/or a static way (e.g., the WTRU may be configured by the network), or there may be a WTRU-side and/or network-side and/or two-sided AI/ML model that dynamically determines and/or predicts which configuration parameters may impact a given KPI (note that the set of configuration parameters that impact the given KPI may vary from time to time depending on current WTRU-side conditions, network-side conditions, etc.).

Another one of these sub-parts refers to when optimization is to be performed. Determining when to perform an optimization may be done in a reactive way (e.g., based on KPI values to monitor) or in a proactive way (e.g., if the WTRU has an AI\ML model to predict when the KPI value is expected to reach a certain threshold and to trigger optimization before the performance has degraded).

Another one of these sub-parts refers to how optimization of the configuration parameters is to be performed. This optimization may be done in a reactive way (e.g., by changing configuration parameter values, checking if the a target value for the KPI is reached, and then either retaining the changes (which may involve asking the network for a confirmation), etc.) or in a proactive way (e.g., if a WTRU has an AI\ML model to predict how a change of a configuration parameter's value will impact a KPI and the WTRU makes the decision to change based on a prediction rather than actual observation).

It should be noted that the AIML models used for the different purposes above (e.g., KPI-to-configuration-parameter relation determination, when to start the optimization, which configuration parameters values to use) may be the same or different AI/ML models and may be used for the different purposes.

1. A wireless transmit/receive unit (WTRU) comprising:
a processor configured to:
receive an indication of a relation between a key performance indicator and a configuration parameter;
receive an indication of a range of values that can be assigned to the parameter and an initial value for the parameter;
receive configuration information, wherein the configuration information indicates a first condition associated with the key performance indicator;
in response to a determination that the first condition has been satisfied, determine an updated value for the configured parameter, wherein the updated value is within the range of the values that can be assigned to the parameter, to achieve a second condition associated with the key performance indicator using a model; and
in response to a determination that the updated value is to be assigned to the configuration parameter, perform one or more of the following actions:
(i) apply the updated value for the configuration parameter at the WTRU;
(ii) send an indication to a network that the updated value for the configuration parameter has been applied at the WTRU; or
(iii) send a request to the network to request that the initial value of the configuration parameter be changed to the updated value.

2. The WTRU of claim 1, wherein the configuration parameter is associated with an information element.

3. The WTRU of claim 1, wherein the configuration parameter is used to configure the WTRU for operation or communication with the network.

4. The WTRU of claim 1, wherein the configuration parameter comprises one or more of: a timer or a counter.

5. The WTRU of claim 1, wherein the key performance indicator comprises a metric that is associated with throughput or latency of communication between the WTRU and the network.

6. The WTRU of claim 1, wherein the processor is further configured to:
send an indication that the WTRU is capable of performing optimization of the key performance indicator by modifying the initial value of the configuration parameter.

7. The WTRU of claim 1, wherein the WTRU is capable of performing the optimization of the key performance indicator by using an artificial intelligence and/or machine-learning (AI/ML) model, and wherein the model comprises the AI/ML model.

8. The WTRU of claim 7, wherein the processor is further configured to:
receive a request from the network for information that indicates whether the AI/ML model is applicable to perform optimization of the key performance indicator by modifying the initial value of the configuration parameter;
determine that the AI/ML model is applicable for performing optimization of the key performance indicator for the WTRU and for current network conditions associated with the network; and
send an applicability report that indicates that the AI/ML model is applicable for performing optimization of the key performance indicator for the WTRU and for the current network conditions associated with the network.

9. The WTRU of claim 1, wherein the first condition comprises one or more of an absolute key performance indicator threshold or a relative key performance indicator threshold.

10. The WTRU of claim 1, wherein the second condition comprises one or more of an absolute key performance indicator threshold or a key performance indicator threshold relative to the first condition.

11. The WTRU of claim 1, wherein the second condition defines an upper bound for the key performance indicator or a lower bound for the key performance indicator.

12. A method performed by a wireless transmit/receive unit, the method comprising:
receiving an indication of a relation between a key performance indicator and a configuration parameter;
receiving an indication of a range of values that can be assigned to the parameter and an initial value for the parameter;
receiving configuration information, wherein the configuration information indicates a first condition associated with the key performance indicator;
in response to a determination that the first condition has been satisfied, determining an updated value for the configured parameter, wherein the updated value is within the range of the values that can be assigned to the parameter, to achieve a second condition associated with the key performance indicator using a model; and
in response to a determination that the updated value is to be assigned to the configuration parameter, performing one or more of the following actions:
(i) applying the updated value for the configuration parameter at the WTRU;
(ii) sending an indication to a network that the updated value for the configuration parameter has been applied at the WTRU; or
(iii) sending a request to the network to request that the initial value of the configuration parameter be changed to the updated value.

13. The method of claim 12, wherein the configuration parameter is associated with an information element.

14. The method of claim 12, wherein the configuration parameter is used to configure the WTRU for operation or communication with the network.

15. The method of claim 12, wherein the configuration parameter comprises one or more of:
a timer or a counter.

16. The method of claim 12, wherein the key performance indicator comprises a metric that is associated with throughput or latency of communication between the WTRU and the network.

17. The method of claim 12, further comprising:
sending an indication that the WTRU is capable of performing optimization of the key performance indicator by modifying the initial value of the configuration parameter.

18. The method of claim 12, wherein the WTRU is capable of performing the optimization of the key performance indicator by using an artificial intelligence and/or machine-learning (AI/ML) model, and wherein the model comprises the AI/ML model.

19. The method of claim 18, further comprising:
receiving a request from the network for information that indicates whether the AI/ML model is applicable to perform optimization of the key performance indicator by modifying the initial value of the configuration parameter;
determining that the AI/ML model is applicable for performing optimization of the key performance indicator for the WTRU and for current network conditions associated with the network; and
sending an applicability report that indicates that the AI/ML model is applicable for performing optimization of the key performance indicator for the WTRU and for the current network conditions associated with the network.

20. A wireless transmit/receive unit (WTRU) comprising:
a processor configured to:
receive an indication of a relation between a key performance indicator and a configuration parameter;
receive configuration information, wherein the configuration information indicates a start condition associated with determining a value for the configuration parameter based on the key performance indicator;
in response to a determination that the start condition has been satisfied, determine the value for the configured parameter to achieve a target value for the key performance indicator using an artificial intelligence and/or machine learning (AI/ML) model; and
in response to a determination that the value for the configuration parameter has been determined, perform one or more of the following actions:
(i) apply the value for the configuration parameter at the WTRU;
(ii) send an indication to a network that the value for the configuration parameter has been applied at the WTRU; or
(iii) send a request to the network to request that a current value of the configuration parameter be changed to match the value.
